(19) United States
(12) Patent Application Publication
(10) Pub. No.: US 2013/0086821 A1
(43) Pub. Date: Apr. 11, 2013

(54) Tread Element and Configuration

(71) Applicant: Jim Lussier, Asbestos (CA)

(72) Inventor: Jim Lussier, Asbestos (CA)

(21) Appl. No.: 13/267,957

(22) Filed: Oct. 7, 2011

(51) Int. Cl. B32B 3/00; A43B 13/22; B60C 11/12

(52) U.S. Cl. 36/25 R; 152/209.18; 428/156

(57) ABSTRACT

The present invention discloses a tread element and a tread configuration to be used with a shoe sole, the outer surface of a tire or the outer surface of a traction band.

### CROSS-REFERENCE TO RELATED APPLICATIONS

There are no cross-related applications.

### FIELD OF THE INVENTION

The present invention relates generally to a tread configuration and, more particularly, to a tread configuration that is particularly adapted to improve adherence, stability, cornering and braking performances of a vehicle tire or a shoe sole on various surface conditions such as, for examples, on a dry pavement, on a gravelous road, on wet, snowy, muddy or icy surfaces, and the likes. The tread configuration of the present invention is further adapted to improve wear resistance of a vehicle tire or a shoe sole equipped thereof.

### BACKGROUND OF THE INVENTION

Over the years, many tread configurations of vehicle tires, endless tracks and shoe soles have been proposed in an attempt to improve such aspects as adherence, stability, wear resistance, cornering and braking performances, and with these aspects being optimized to perform in the widest range of surface conditions possible. The most common surface conditions that a vehicle tire or a shoe sole may encounter being, for examples, earth, grassy, gravelous, sandy, snowy and/or muddy surfaces, as well as slick pavements or smooth icy surfaces, in either wet or dry conditions.

Noticeable examples of tire tread configurations of the prior art are U.S. Pat. Nos. USD571712, to Ohigashi (2008), U.S. Pat. Nos. USD554575, to Sakakibara et Al. (2007), U.S. Pat. Nos. USD548676, to Nishimori (2007), and U.S. Pat. Nos. US5725700,to Ichiki (1998). Noticeable examples of a tread configuration of a shoe sole are U.S. Pat. Nos. USD560334, to Valle (2008), U.S. Pat. Nos. USD414021, to James (1999), and U.S. Pat. Nos. USD385987, to Bramani (1997).

While these prior art tread configurations may provide improved performance characteristics in some of the aspects of a vehicle tire, as described above, none really achieve improvements in the combined aspects of traction, flexibility and wear resistance, since these aspects are generally contradictory by nature.

Against this background, there exist a need for a new and improved tread configuration for vehicle tires, endless tracks and shoe soles.

### SUMMARY OF THE INVENTION

The present invention is generally providing a tread element for use on the outer surface of a ground engaging outer surface, the tread element having a front end, a rear end, elongated side edges, and a ground contacting top surface, wherein the tread element has a truncated triangle shape, the tread element comprising a front end defined by at least one inwardly oriented V-shaped recess; a rear end defined by at least two side by side, inwardly oriented V-shaped recesses; an aligned recess substantially centrally disposed along the longitudinal axis of the tread element and at least one substantially zigzag-shaped sipe extending laterally across the full width of the tread element.

The present invention is also providing a tread configuration for use on the outer surface of a ground engaging outer surface, the tread configuration comprising a plurality of tread elements comprising a front end defined by at least one inwardly oriented V-shaped recess; a rear end defined by at least two side by side, inwardly oriented V-shaped recesses; an aligned recess substantially centrally disposed along the longitudinal axis of the tread element; at least one substantially zigzag-shaped sipe extending laterally across the full width of the tread element; and wherein the tread elements are grouped in an arch-shaped tread pattern centrally distributed along the longitudinal axis of the ground engaging outer surface and wherein the tread configuration is repeated at a given interval on the ground engaging outer surface.

It is a general object of the present invention to provide a new and improved tread configuration that is particularly suited for vehicles tires, endless track and shoe soles.

In a first preferred embodiment, according to the present invention, the tread configuration is applied to the sole of a vehicle tire. In the present embodiment, the tread configuration has a directional tread design and generally comprises a plurality of protruding tread elements that are integrally formed and suitably distributed along the outer circumferential surface of a tire. A directional tire tread design is a tread structure that is intended to operate more efficiently when rotated in one direction than in the opposite direction.

The plurality of tread elements are arranged in a predefined tread pattern that repeats itself throughout the outer circumference of the tire.

The predefined tread pattern has a substantially arch-shaped configuration whose distal ends extend in a widthwise direction relative to the circumferential surface of the tire, and its rounded apex directed opposite the directional rotation of the tread configuration.

A plurality of tread elements, for example, seven tread elements, is distally arranged in a substantially fan-shaped configuration, within the correspondingly arch-shaped configuration of a tread pattern.

Each tread element has roughly the shape of a substantially elongated, truncated triangle having a front end and a rear end, with each end substantially defining inwardly oriented V-shaped recesses. The tread element is further characterized by a pair of elongated side edges, a plurality of transversally extending zigzag-shaped sipes that are suitably spaced apart in a parallel fashion along the longitudinal axis of the tread element, a substantially centrally disposed diamond shaped recess, and a ground contacting top surface.

The individual tread element configuration, in cooperative relation with the spatial disposition of the plurality of tread elements in a tread pattern having a fan-shaped configuration, provide enhanced ground penetration and adherence qualities to a tire, particularly on textured ground surfaces such as, for examples, on earth, gravelous, sandy, snowy and/or muddy roads, and in either wet or dry conditions.

Furthermore, the fan-shaped disposition of the tread elements form a plurality of radially outwardly directing channels between the elongated elements, which channels roughly communicate from one tread pattern to the subsequent one. The thus formed subsequent directing channels help expel the fluids and/or loose material, such as water, mud, snow, sand and/or gravel, from the ground surface towards the lateral sides of the tire, particularly when the latter rotates in the directional rotation of the tread configuration. Thus, the directing channels further enhance the ground penetration and adherence qualities of a vehicle tire and reduce the risk of aquaplaning in heavy conditions.

The plurality of laterally extending zigzag-shaped sipes provides a tread element having improved flexibility, which enhance the wear resistance qualities of the tire. The centrally disposed diamond-shaped recess provides, when pressed against the ground surface, a suction cup effect that enhances the adherence qualities of the tire, particularly on smooth and uniform surfaces such as, for examples, an icy surface or a slick pavement, in either wet or dry conditions.

An important aspect of the present invention relates to the fact that at least one of the laterally extending zigzag-shaped sipes intersect through the centrally disposed diamond-shaped recess. This particular arrangement provides a tread element that combines both qualities of improved wear resistance and a suction cup effect in a relatively compact tread element.

Furthermore, the general structure and configuration of the tread element, as described above, provides improved traction, flexibility, as well as adherence characteristics, all integrated in a substantially compact format, which represent combined characteristics that are not commonly found in tread elements of the prior art since these characteristics are contradictory by nature. Consequently, because of the general structure and configuration of the tread element, it is possible to have a tread configuration for a vehicle tire that is made of a relatively high-hardness rubber, which further improves the wear resistance characteristics of the tire.

In a second preferred embodiment, according to the present invention, the tread configuration is applied to the sole of a shoe.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1: is an enlarged fragmentary, perspective view of a tire tread configuration according to the present invention, it being understood that the tread configuration repeats uniformly throughout the outer circumference of the tire;

FIG. 2: is a partial top elevational view of the tire tread configuration in FIG. 1;

FIG. 3: is a fragmentary, cross-sectional view of a tire taken along the equatorial plane of a tire tread, while the tire is pressed against a ground surface;

FIG. 4: is an enlarged top plan view of a single tread element in an uncompressed state, such as when the tread element is not in contact with a ground surface;

FIG. 5: is a top plan view of the single tread element in FIG. 4, here shown in a longitudinally compressed state;

FIG. 6: is bottom plan view of a shoe sole according to the present invention.

### DETAILED DESCRIPTION OF THE PREFERRED EMBODIMENT

A novel tread configuration will be described hereinafter. Although the invention is described in terms of specific illustrative embodiment(s), it is to be understood that the embodiment(s) described herein are by way of example only and that the scope of the invention is not intended to be limited thereby.

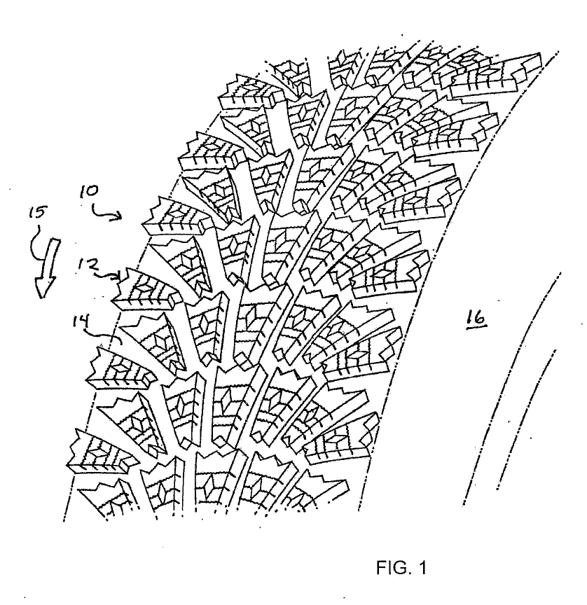

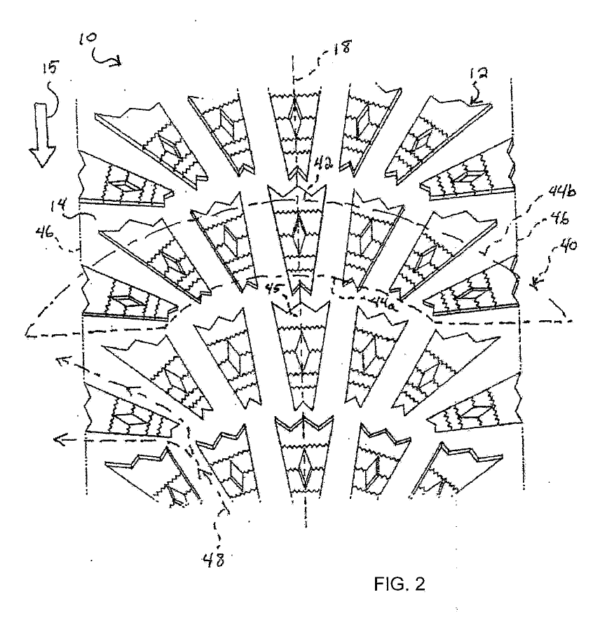

FIGS. 1 and 2 best show the various aspects of a first preferred embodiment of a tread configuration 10, according to the present invention, wherein the tread configuration 10 is applied to the sole of a vehicle tire 16. The tire tread configuration 10 is generally defined by a plurality of protruding tread elements 12 integrally formed and suitably distributed along the outer circumferential surface 14 of a tire 16. The tire tread configuration 10 has a directional tread design whose preferred directional rotation is indicated by arrow 15 on the drawings.

It is to be noted that the same tread elements and tread configuration could be used on a traction band and benefits from the same advantages.

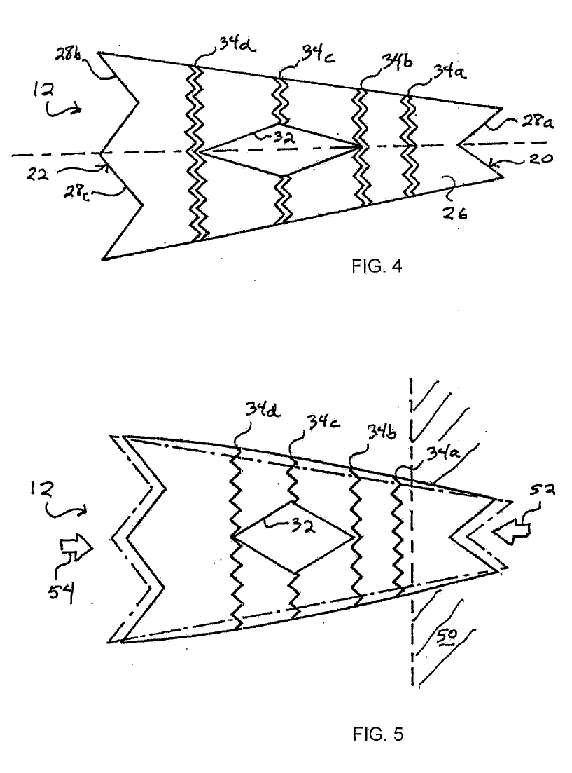

FIG. 4 shows a top plan view of a typical shape of a tread element 12, such as can be found, for example, longitudinally aligned along the equatorial centerline plane 18 of the tread configuration 10 (as best illustrated in FIG. 2). The tread element 12 has substantially the shape of a truncated triangle that is generally defined by a front end 20, a rear end 22, elongated side edges 24, and a ground contacting top surface 26. Front end 20 is generally defined by an inwardly oriented V-shaped recess 28a. In a similar fashion, rear end 22 is generally defined by a pair of side by side, inwardly oriented V-shaped recesses 28b and 28c.

As it will be explained in details more below, the geometrical configuration of the inwardly oriented V-shaped recesses 28a-c defining the front 20 and rear end 22 of the tread element 12 may vary depending on the spatial disposition of the tread element 12 relative to the equatorial centerline plane 18 of the tread configuration 10.

Furthermore, it is to be understood that the front end 20 may define more than one V-shaped recess, and the rear end 22 may as well define only one, or more than two V-shaped recesses.

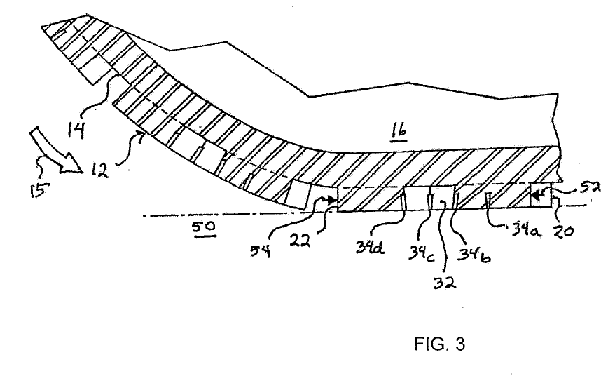

Substantially centrally disposed along the longitudinal axis 30 of the tread element 12 there is provided an elongated and longitudinally aligned diamond-shaped recess 32. It is to be understood that recess 32 may have any other suitable shape such as, for examples, oval, rectangular, or the likes. The diamond-shaped recess 32 may have a depth that extends between a quarter and a full depth of the tread element 12. Preferably, the depth of the diamond-shaped recess 32 extends the whole depth of the tread element 12, as best illustrated in FIG. 3.

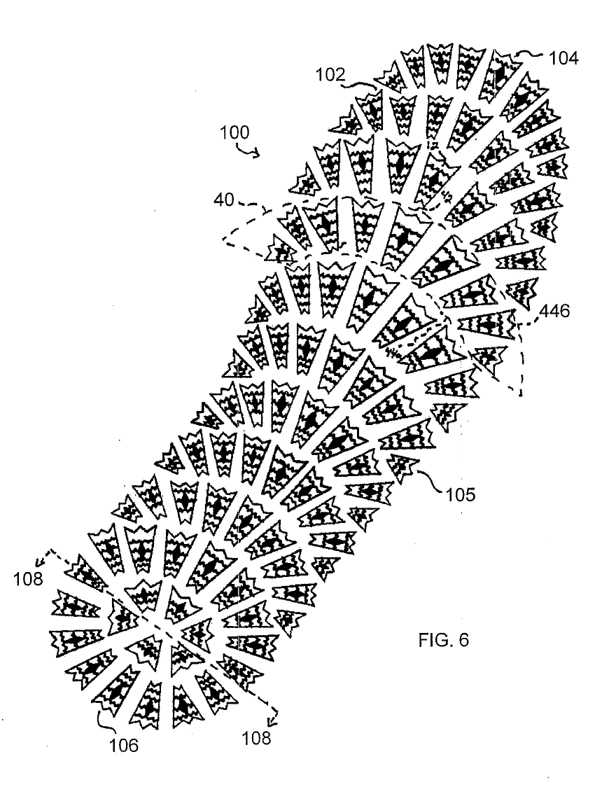

The planar surface area occupied by the diamond-shaped recess 32 may represent between 10% and 70% of the overall planar area occupied by the tread element 12. Preferably, the diamond-shaped recess 32 may represent roughly 15% of the overall planar area occupied by the tread element 12, as exemplified in FIGS. 4 and 5.

A plurality, but preferably four substantially zigzag-shaped sipes 34a-d extends laterally across the full width of the tread element 12. Preferably, a first sipe 34a laterally extends roughly half-way between the inward apex of the front end 20 and the front tip end of the diamond-shaped recess 32, a second sipe 34b laterally extends adjacent the front tip end of the diamond-shaped recess 32, a third sipe 34c laterally extends in two linearly corresponding segments across a mid portion of the diamond-shaped recess 32, and a fourth sipe 34d laterally extends adjacent the rear tip end of the diamond-shaped recess 32. It is to be understood that the relative position of each laterally extending sipes 34a-d may slightly differ.

Likewise the diamond-shaped recess 32 described above, the depth extent of the zigzag-shaped sipes 34a-d through the ground contacting surface 26 of the tread element 12 may uniformly or individually extend between a quarter and a full depth of the element 12. Preferably, the depth extent of the zigzag-shaped sipes 34a-d uniformly extend roughly two third of the depth of the tread element 12 relative to the ground contacting surface 26, as best illustrated in FIGS. 1 and 3.

As it will be described in more details below, the laterally extending zigzag-shaped sipes 34a-d provide improved longitudinal flexibility to the tread element 12, as well as securing the longitudinal alignment of the various portions of the latter when it is compressed longitudinally.

Now referring more particularly to FIGS. 1 and 2, the spatial disposition of the tread elements 12 along the outer circumferential surface 14 of a tire 16 is such that a predefined tread pattern 40 may be defined thereon.

The predefined tread pattern 40, which includes a plurality of tread elements 12, may be generally delimited by a dash-dotted line that is defining a substantially arch-shaped configuration. The predefined tread pattern 40 has a width that is extending in the widthwise direction of the circumferential surface of the tire 16. The arch-shaped tread pattern 40 is further defined by an inner and an outer arch-shaped imaginary line 44a and 44b respectively, whose general focal point 45 is generally directed towards the directional rotation 15 of the tread configuration 10, and is centered with respect to the equatorial centerline plane 18. The tread pattern 40 is thus repeated at a given interval in the circumferential direction of the tire.

A plurality, but preferably seven tread elements 12 are distally arranged in a substantially fan-shaped configuration, within the arch-shaped tread pattern 40, wherein the front ends 20 of the tread elements 12 are substantially directed towards the common focal point 45, and the rear ends 22 are directed radially outwardly thereof.

Thus, the front ends 20 of the tread elements 12 disposed relatively near the equatorial centerline plane 18 are generally pointing towards the same direction as the traction force that is generally applied to the sole of the tire 16, relative to a contact surface, such as when a vehicle starts or accelerate in a forward direction.

The inclination of the longitudinal axis 30 of a tread element 12 within the fan-shaped pattern 40, relative to the equatorial centerline plane 18 of the tread configuration 10, may vary from zero degree to 90 degree. Preferably, the inclination of the longitudinal axis 30 may vary from zero degree to roughly 83 degree relative to the equatorial centerline plane 18.

The relative distance between adjacent tread elements 12 is suitably sized such that a high fluid drainage performance may be achieved. Furthermore, the overall dimensions of the tread elements 12 near the lateral sides of the fan-shaped tread pattern 40 may be relatively smaller that the tread elements within the central portion of the pattern 40. Preferably, the tread elements 12 near the lateral sides of the pattern 40 are roughly 20% smaller than the tread elements 12 in the central portion of the pattern 40.

The distal pointed ends at the front end 20 of the tread elements 12 are geometrically configured such that they roughly align with the laterally extending, inner arch-shaped imaginary line 44a of the tread pattern 40. In a similar manner, the distal pointed ends at the rear ends 22 of the tread elements 12 are geometrically configured such that they roughly align with the outer arch-shaped imaginary line 44b of the tread pattern 40.

As can be observed in FIG. 2, the pair of tread elements 12 that are oppositely disposed at the lateral distal ends of the arch-shaped tread pattern 40, have the distal pointed ends of their rear ends 22 suitably geometrically configured such that they are substantially aligned with the lateral delimitations 46 of the tread configuration 10, rather than with the radially corresponding segment of the outer imaginary line 44b of the tread pattern 40, as is the case with the other tread elements of the pattern.

It is to be understood that a predefined tread pattern 40 may include a fewer, or a higher number of tread elements 12 as described above. As well, subsequent tread patterns 40 may include different numbers of tread elements 12. Furthermore, some or all of the front and rear ends 20, 22 of the tread elements 12 may slightly protrude or may be slightly recessed relative to the inner and outer arch-shaped imaginary lines 44a and 44b respectively. For example, as can be observed in FIG. 2, the front end 20 of the tread element 12 disposed at the center of the arch-shaped tread pattern 40 slightly protrude the general guide line represented by the inner arch-shaped imaginary line 44a.

In use, a vehicle tire 16 provided with the preferred embodiment of a tire tread configuration 10, as described above, has improved adherence with regards to starting, driving stability, cornering and braking performances in various road surface conditions.

For examples, the V-shaped recess 28a defined at the front end 20 of the tread elements 12 provides enhanced ground penetration and adherence qualities to a vehicle tire mainly when the tire rotates in the directional rotation 15 of the tread configuration 10, such as when the tire starts to rotate or its rotational movement accelerates forwardly.

In a similar fashion, the pair of side by side V-shaped recesses 28b and 28c defined at the rear end 22 of the sub-group of five tread elements 12 centered within the arch-shaped tread pattern 40, provide enhanced ground penetration and adherence qualities to a vehicle tire mainly when the tire rotates opposite the directional rotation 15 of the tread configuration 10, such as when the tire stops rotating or its rotational movement accelerates rearwardly.

The V-shaped recesses 28b and 28c defined at the rear end 22 of the pair of tread elements 12 that are oppositely disposed at the lateral distal ends of the arch-shaped tread pattern 40, provide enhanced ground penetration and adherence qualities of a vehicle tire mainly when the tire is forced into a substantially sideward trajectory relative to the ground, such as when the vehicle is cornering or skidding sideward.

It is to be noted that the V-shaped recesses 28a-c provide enhanced ground penetration and adherence qualities to the tire, particularly on textured ground surfaces such as, for examples, on earth, gravel, sandy, snowy and/or muddy roads, and in either wet or dry conditions. It is further to be noted that the elongated side edges 24 of the tread elements 12 that are at an angle relative to the equatorial centerline plane 18 of the tread configuration 10 further enhance the ground penetration and adherence qualities of the latter on the various roads conditions described above.

Furthermore, the fan-shaped distribution of the tread elements 12 within a tread pattern 40 form a plurality of radially directing channels 48 therebetween, which roughly communicate from one tread pattern 40 to the subsequent one, as illustrated in FIG. 2.

The thus roughly formed subsequent directing channels 48 help expel fluids and/or loose material, such as water, mud, snow, sand an/or gravel, from the ground surface towards the lateral sides of the tire, when the latter rotates in the directional rotation 15 of the tread configuration 10. Thus, the directing channels 48 further enhance the ground penetration and adherence qualities of a vehicle tire.

Furthermore, as exemplified in FIG. 5, when the tire rotates, for example, in the rotational direction 15 of the tread configuration 10, the front end 20 of a tread element 12 first gets in contact with the contacting ground surface 50, which exerts an opposing frictional force 52 against the resilient material that composes the tread element 12.

While the top surface 26 at the front end portion of the tread element 12 is thus relatively blocked against the contacting ground surface 50, the rotational power of the tire continues to exert a forward force 54 in the rotational direction 15 on the remaining rear portion of the tread element 12 that is not yet in contact with the ground surface 50. Thus, the forward force 54 longitudinally compresses the rear end portion of the tread element 12 against the blocked front end portion which, in turn compresses the zigzag-shaped sipes 34a-d in a substantially closed configuration, as illustrated in FIG. 5.

As the tire 16 keeps rotating, the whole ground contacting surface 26 of the tread element 12 ends up longitudinally compressed, as well as flatly compressed against the contacting ground surface 50, as illustrated in FIG. 3.

It is to be noted that the compressed state of a tread element 12 against a contacting ground surface 50, as described above, is mainly applicable to the centered five tread elements 12 of the tread pattern 40, when a tires provided with the tread configuration 10 of the present invention is rotating forward or backward relative to the ground. A substantially similar compressed state is applicable to the pair of tread elements 12 at each distal ends of the tread pattern 40, when the tire is skidding sideward.

Furthermore, substantially the same compressed state of a tread element 12 against a contacting ground surface 50 may be achieved when the tire rotates opposite the rotational direction 15 of the tread configuration 10.

Hence, with the zigzag-shaped sipes 34a-d thus compressed in a closed configuration, the result is a substantially hermetically closed cell represented by the centrally disposed, diamond-shaped recess 32, which induces a suction cup effect between the tread element 12 and the contacting ground surface 50, when the tread element 12 is flatly pressed thereon. The suction cup effect created by the diamond-shaped recess 32 provides enhanced adherence qualities to the tire, and is particularly effective on a smooth and uniform surface such as, for examples, an icy surface or a slick pavement, in either wet or dry conditions.

It is important to note that the plurality of transversal zigzag-shaped sipes 34a-d provide longitudinal flexibility to the tread element 12, which enhance the wear resistance qualities of the tire, while still allowing the provision of a substantially hermetically closed cell, represented by the centrally disposed diamond-shaped recess 32, which enhance the adherence qualities of the tire, as described above.

Furthermore, the general structure and configuration of the tread element 12, as described above, provides a tread element having improved performances in the combined aspects of traction, flexibility, as well as wear resistance, all integrated in a substantially compact format, which represent improved performances in combined aspects that are not commonly found in tread elements of the prior art since these aspects are generally contradictory by nature. Furthermore, because of the general structure and configuration of the tread element 12, it is possible to have a tread configuration 10 for a vehicle tire 16 that is made of a relatively high-hardness rubber, which further improve the wear resistance characteristics of the tire.

FIG. 6 shows a second preferred embodiment of a tread configuration 100, according to the present invention, wherein the tread configuration 100 is applied to the sole 102 of a shoe. It is to be noted that the expression shoe encloses shoes, boots, open shoes, etc . . . The shoe sole 102 is conventionally defined has having a toe end portion 104, an intermediate portion 105, and a heel end portion 106. In a similar fashion as with the sole of the vehicle tire 16 described above, the shoe sole 102 is provided with a plurality tread elements 12 generally grouped in arch-shaped tread patterns 40 that are centrally distributed along the longitudinal axis of the sole.

The arch-shaped tread patterns 40 have their apex 42 generally centered and oriented towards the toe end portion 104 of the sole, except for a rear-half portion 108 of the heel end portion 106 whose tread patterns 40 have their apex 42 oriented in an opposite direction.

Thus, the front ends 20 of the tread elements 12 disposed relatively near the longitudinal axis of the sole, and distributed along the toe end portion 104, the intermediate portion 105, and part of the heel end portion 106, are generally pointing towards the same direction as the traction force generally applied to a shoe sole 102 relative to a contact surface when, for examples, a person starts to run or accelerate in a forward direction.

In a similar, but oppositely oriented configuration, the front ends 20 of the tread elements 12 disposed in the rear-half portion 108 of the heel end portion 106 are generally pointing towards the same direction as the traction force generally applied to a shoe sole 102 relative to a contact surface when, for examples, a person stops or decelerates from a forward movement by applying pressure on the rear-half portion 108 of the heel end portion 106 of the shoes.

The performance characteristics of the tread configuration 100 applied to a shoe sole are substantially similar to the performance characteristics of the tire tread configuration 10 described above in terms of traction, adherence, and wear resistance.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A tread element for use on the outer surface of a ground engaging outer surface, said tread element having a front end, a rear end, elongated side edges, and a ground contacting top surface, wherein said tread element has a truncated triangle shape, said tread element comprising:
a) a front end defined by at least one inwardly oriented V-shaped recess;
b) a rear end defined by at least two side by side, inwardly oriented V-shaped recesses;
c) an aligned recess substantially centrally disposed along the longitudinal axis of said tread element; and
d) at least one substantially zigzag-shaped sipe extending laterally across the full width of said tread element.

2) The tread element of claim 1, wherein said recess has a shape selected from the group consisting of diamond-shape, oval, rectangular, or the likes.

3) The tread element of claim 1, wherein the depth of said recess extends between a quarter and a full depth of said tread element.

4) The tread element of claim 1, wherein the planar surface area occupied by said recess vary between 10% and 70% of the overall planar area occupied by said tread element.

5) The tread element of claim 1, wherein the planar surface area occupied by said recess represent 15% of the overall planar area occupied by said tread element.

6) The tread element of claim 1, wherein said tread element comprises four substantially zigzag-shaped sipes.

7) The tread element of claim 1, wherein said tread element comprises a first sipe laterally extending roughly half-way between the inward apex of said front end and the front tip end of said recess, a second sipe laterally extending adjacent the front tip end of said recess, a third sipe laterally extending in two linearly corresponding segments across a mid portion of said recess, and a fourth sipe laterally extending adjacent the rear tip end of said recess.

8) The tread element of claim 1, wherein the depth of said sipe extends between a quarter and a full depth of said tread element.

9) The tread element of claim 1, wherein said ground engaging outer surface is part of an element selected from the group consisting of shoe sole, tire and traction band.

10) A tread configuration for use on the outer surface of a ground engaging outer surface, said tread configuration comprising:
a) a plurality of tread elements comprising:
i) a front end defined by at least one inwardly oriented V-shaped recess;
ii) a rear end defined by at least two side by side, inwardly oriented V-shaped recesses;
iii) an aligned recess substantially centrally disposed along the longitudinal axis of said tread element;
iv) at least one substantially zigzag-shaped sipe extending laterally across the full width of said tread element; and
wherein said tread elements are grouped in an arch-shaped tread pattern centrally distributed along the longitudinal axis of said ground engaging outer surface and wherein said tread configuration is repeated at a given interval on said ground engaging outer surface.

11) The tread configuration of claim 10, wherein said tread configuration has a width that is extending in the widthwise direction of said ground engaging outer surface.

12) The tread configuration of claim 10, wherein said tread elements are distally arranged in a substantially fan-shaped configuration within said arch-shaped tread pattern, wherein said front ends of said tread elements are generally pointing towards the same direction as the traction force that is generally applied to said ground engaging outer surface.

13) The tread configuration of claim 10, wherein the inclination of the longitudinal axis of a said tread element within said fan-shaped pattern, relative to the longitudinal axis of said ground engaging outer surface, may vary from zero degree to 90 degree.

14) The tread configuration of claim 10, wherein the inclination of the longitudinal axis of a said tread element within said fan-shaped pattern, relative to the longitudinal axis of said ground engaging outer surface, may vary from zero degree to roughly 83 degree.

15) The tread configuration of claim 10, wherein the overall dimensions of the tread elements near the lateral sides of said fan-shaped tread pattern may be relatively smaller that the tread elements within the central portion of said pattern.

16) The tread configuration of claim 10, wherein the tread elements near the lateral sides of the pattern are roughly 20% smaller than the tread elements in the central portion of said pattern.

17) The tread configuration of claim 10, wherein at least one of said front and rear ends of said tread elements protrude or are recessed relative to the inner and outer arch-shaped respectively.

18) The tread configuration of claim 10, wherein said ground engaging outer surface is part of an element selected from the group consisting of shoe sole, tire and traction band.

19) The tread configuration of claim 18, wherein said arch-shaped tread patterns for a shoe sole have their apex generally centered and oriented towards the toe end portion of said sole, except for a rear-half portion of the heel end portion whose tread patterns have their apex oriented in an opposite direction.
